(19) United States
(12) Patent Application Publication
(10) Pub. No.: US 2024/0009876 A1
(43) Pub. Date: Jan. 11, 2024

(54) Cutting Board Assembly

(71) Applicant: Tapan Saha, Hendersonville, TN (US)

(72) Inventor: Tapan Saha, Hendersonville, TN (US)

(21) Appl. No.: 17/860,596

(22) Filed: Jul. 8, 2022

(51) Int. Cl. B26D 1/30; B26D 7/01

(52) U.S. Cl. CPC B26D 1/30; B26D 7/01

(57) ABSTRACT

A cutting board assembly for cutting large food items includes a cutting board which has dimensions sufficient to accommodate a watermelon. The cutting board has a blade slot extending along a full length of the cutting board. A clamp is coupled to the cutting board for engaging a support panel when the clamp is tightened for securing the cutting board to the support panel. A blade is pivotally coupled to the cutting board for cutting a food item positioned on the cutting board. A handle is attached to the blade thereby facilitating the handle to be gripped for moving the blade upwardly and downwardly.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A

COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to cutting devices and more particularly pertains to a new cutting device for cutting large food items. The device includes a cutting board and a clamp attached to the cutting board for securing the cutting board to a support panel. The device includes a blade that is pivotally coupled to the cutting board for cutting a food item placed on the cutting board.

### (2) Description of Related Art Including Information Disclosed Under 37 CFR 1.97 and 1.98

The prior art relates to cutting devices including a cutting board with a clamp and a plurality of blades pivotally disposed on the cutting board for cutting a food item into a plurality of strips. The prior art discloses a watermelon slicer including a housing, a plurality of tines being disposed in the housing for securing a watermelon and a blade pivotally coupled to the housing for cutting the watermelon. The prior art discloses a slicer assembly that includes a cutting board with a cutting slot and a blade pivotally coupled to the cutting board. The prior art discloses a melon cutting device that includes a movable butt plate and a cutting blade for cutting watermelons into slices. The prior art discloses a cutting board device that includes a cutting board, spikes protruding upwardly from the cutting board and a blade pivotally coupled to the cutting board.

### (h) BRIEF SUMMARY OF THE INVENTION

An embodiment of the disclosure meets the needs presented above by generally comprising a cutting board which has dimensions sufficient to accommodate a watermelon. The cutting board has a blade slot extending along a full length of the cutting board. A clamp is coupled to the cutting board for engaging a support panel when the clamp is tightened for securing the cutting board to the support panel. A blade is pivotally coupled to the cutting board for cutting a food item positioned on the cutting board. A handle is attached to the blade thereby facilitating the handle to be gripped for moving the blade upwardly and downwardly.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a cutting board assembly according to an embodiment of the disclosure.

FIG. 2 is a left side view of an embodiment of the disclosure.

FIG. 3 is a front view of an embodiment of the disclosure.

FIG. 4 is a bottom view of an embodiment of the disclosure.

FIG. 5 is a left side in-use view of an embodiment of the disclosure.

FIG. 6 is a top perspective in-use view of an embodiment of the disclosure.

### (j) DETAILED DESCRIPTION OF THE INVENTION

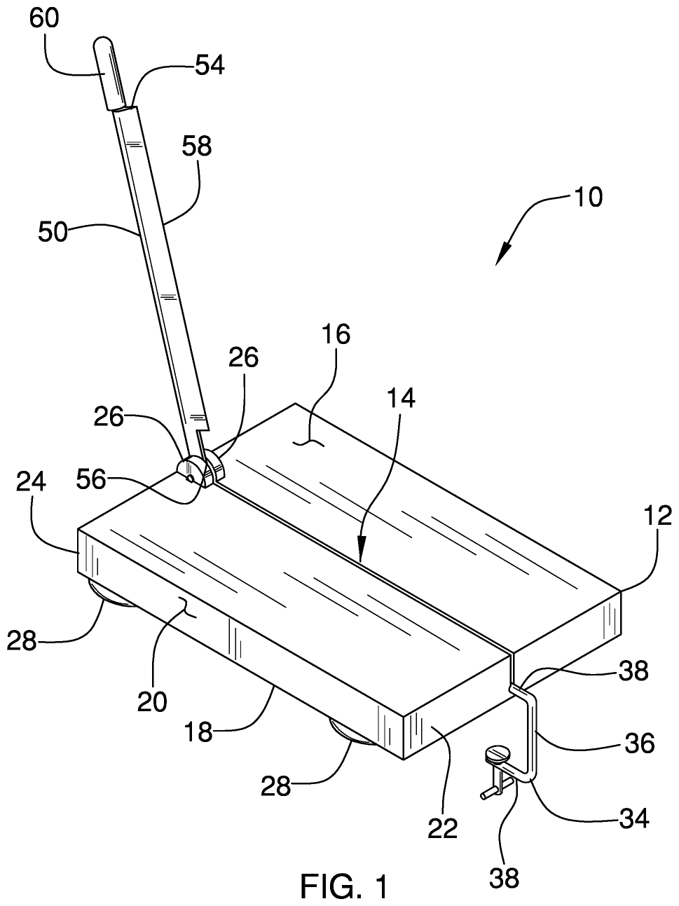

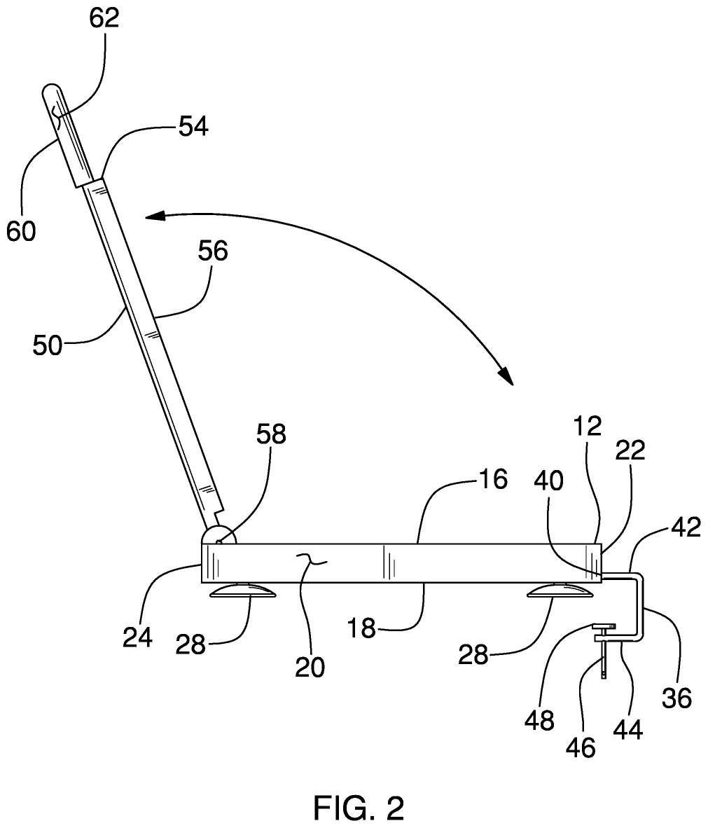

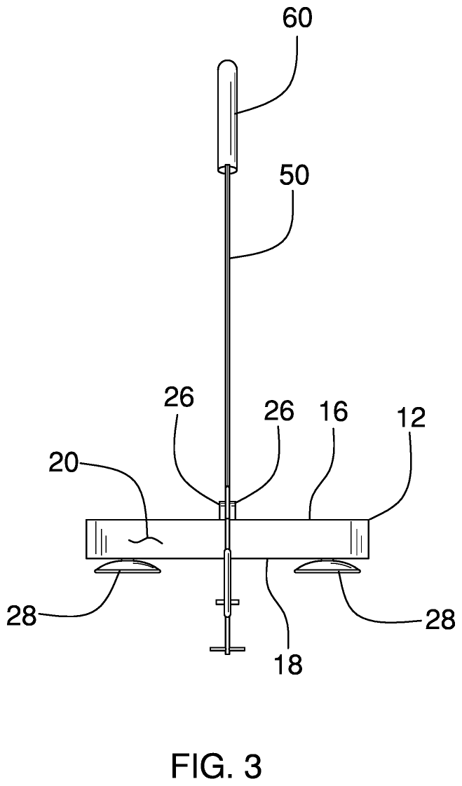

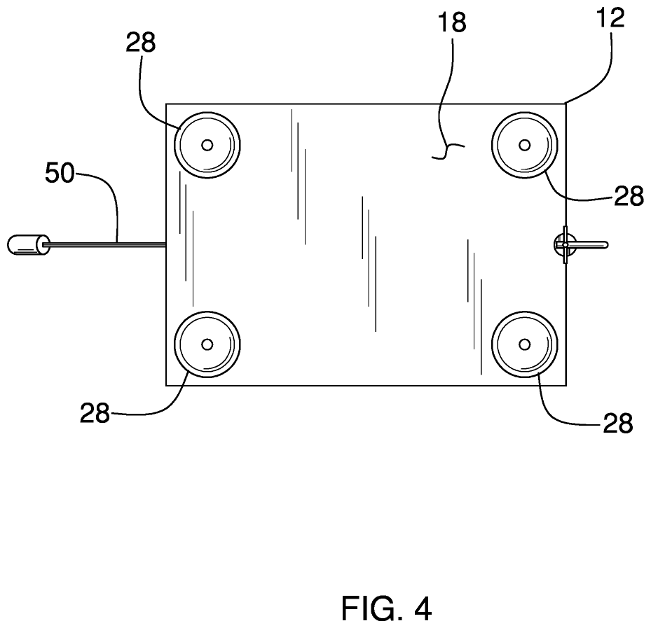

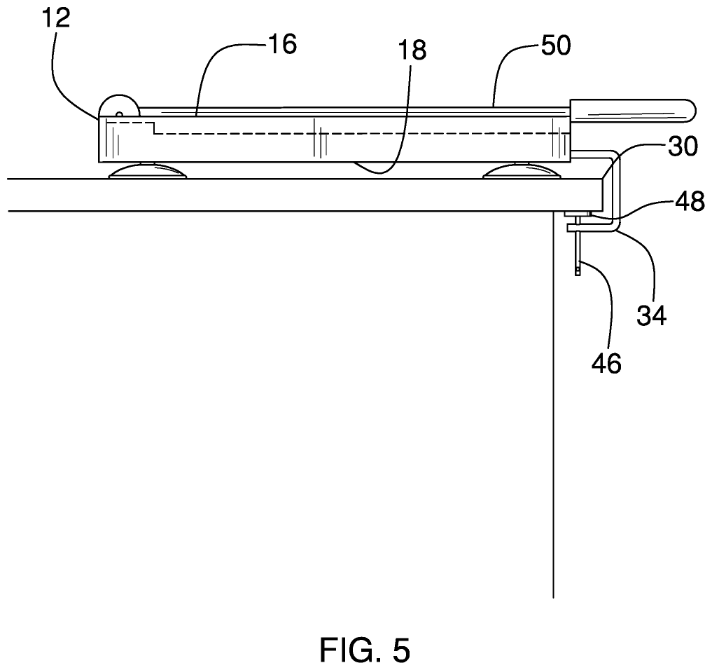

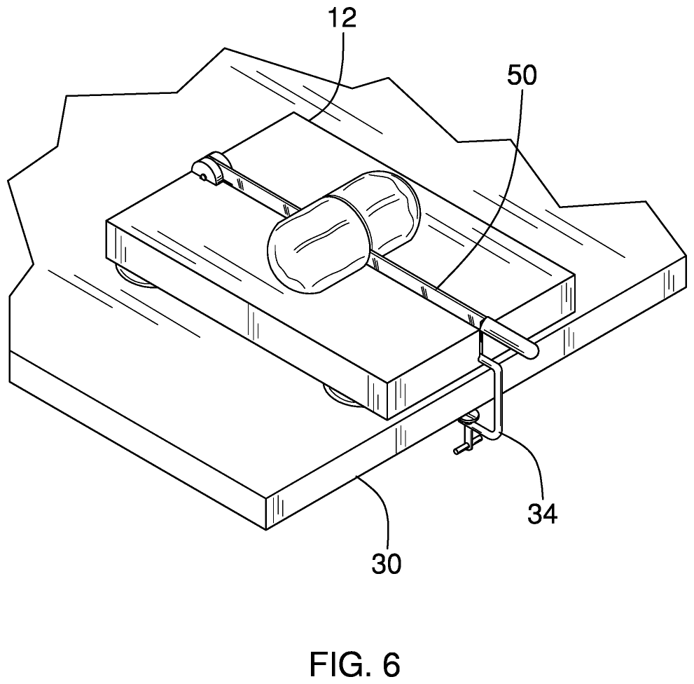

With reference now to the drawings, and in particular to FIGS. 1 through 6 thereof, a new cutting device embodying the principles and concepts of an embodiment of the disclosure and generally designated by the reference numeral 10 will be described.

As best illustrated in FIGS. 1 through 6, the cutting board assembly 10 generally comprises a cutting board 12 that has a width ranging between approximately 30.0 cm and 40.0 cm and a length ranging between approximately 40.0 cm and 50.0 cm. Additionally, the cutting board 12 has a blade slot 14 extending along a full length of the cutting board 12. The cutting board 12 has a top surface 16, a bottom surface 18 and a perimeter surface 20 extending between the top surface 16 and the bottom surface 18, and the perimeter surface 20 has a front side 22 and a back side 24. The blade slot 14 extends downwardly into the top surface 16 and the blade slot 14 extends through the front side 22 and the back side 24 of the perimeter surface 20. Furthermore, the blade slot 14 is centrally positioned on the cutting board 12.

The cutting board 12 has a pair of lobes 26 each extending upwardly from the top surface 16. Each of the lobes 26 is positioned to extend along opposite sides of the blade slot 14 with respect to each other. Additionally, each of the lobes 26 extends from the back side 24 of the perimeter surface 20 toward the front side 22 of the perimeter surface 20. A plurality of couplers 28 is each coupled to the cutting board 12 thereby facilitating each of the couplers 28 to releasably engage a support panel 30 for mounting the cutting board 12 on the support panel 30. Each of the couplers 28 is positioned on the bottom surface 18 of the cutting board 12 and each of the couplers 28 is aligned with a respective one of four corners 32 of the perimeter surface 20. The support panel 30 may be a table top, a counter top or other type of horizontal support surface that might be found in a kitchen, for example. Each of the couplers 28 may comprise a suction cup or other type of coupler that can engage a planar surface.

A clamp 34 is coupled to the cutting board 12 thereby facilitating an edge of the support panel 30 to be positioned in the clamp 34. The clamp 34 engages the support panel 30 when the clamp 34 is tightened for securing the cutting board 12 to the support panel 30. The clamp 34 comprises a central member 36 extending between a pair of end members 38, and each of the end members 38 is perpendicularly oriented with the central member 36 such that the clamp 34 has a U-shape. A distal end 40 of a top one of the end members 42 is coupled to the front side 22 of the perimeter surface 20 such that the central member 36 extends downwardly from the cutting board 12. Additionally, a bottom one of the end members 44 extends along a line that is oriented parallel with the bottom surface 18 of the cutting board 12.

The clamp 34 includes a screw 46 extending through the bottom end member 44. The screw 46 has a plate 48 that is urgeable toward the top end member 42 when the screw 46 is tightened thereby facilitating the support panel 30 to be compressed between the plate 48 and the top end member 42. Conversely, the plate 48 is urgeable away from the top end member 42 when the screw 46 is loosened thereby facilitating the support panel 30 to be removed from between the plate 48 and the top end member 42.

A blade 50 is provided and the blade 50 is pivotally coupled to the cutting board 12. The blade 50 is urgeable downwardly for cutting a food item 52 positioned on the cutting board 12. The blade 50 is aligned with the blade slot 14 thereby facilitating the blade 50 to pass into the blade slot 14 when the blade 50 is urged downwardly for fully cutting through the food item 52. The blade 50 has a first end 54, a second end 56 and a cutting edge 58 extending between the first end 54 and the second end 56. Furthermore, the blade 50 is elongated between the first end 54 and the second end 56 to a length that is at least equal to the length of the cutting board 12. The second end 56 is positioned between the pair of lobes 26 and a pin 58 extends through each of the lobes 26 and engages the blade 50 such that the blade 50 is pivotally attached to each of the lobes 26. The cutting edge 58 of the blade 50 forms an angle of approximately 105.0 degrees with the top surface 16 of the cutting board 12 with the blade 50 is positioned in an upright position.

A handle 60 is attached to the blade 50 thereby facilitating the handle 60 to be gripped for moving the blade 50 upwardly and downwardly. The handle 60 is positioned on the first end 54 of the blade 50 having the handle 60 extending along an axis extending between the first end 54 and the second end 56 of the blade 50. The handle 60 has a rounded outer surface 62 such that the handle 60 has a cylindrical shape for enhancing comfort for the user.

In use, the couplers 28 and the clamp 34 are secured to the support panel 30 and the food item 52, such as a melon, a head of cabbage or any other type of food item 52 that would be difficult to cut with a hand held knife, is positioned on the cutting board 12. The handle 60 is gripped and the blade 50 is urged downwardly to cut the food item 52. In this way the food item 52 is cut in a safe and efficient manner as compared to cutting the food item 52 with a hand held knife. Furthermore, a food item 52 of any size can be cut on the cutting board 12 with the blade 50. In this way the cutting board 12 and the blade 50 can fulfill any cutting needs in a kitchen or a food preparation environment.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A cutting board assembly being attachable to a support panel for cutting large vegetables, said assembly comprising:
a cutting board having a blade slot extending along a full length of said cutting board;
a plurality of couplers, each of said couplers being coupled to said cutting board thereby facilitating each of said couplers to releasably engage a support panel for mounting said cutting board on the support panel;
a clamp being coupled to said cutting board thereby facilitating an edge of the support panel to be positioned in said clamp, said clamp engaging the support panel when said clamp is tightened for securing said cutting board to the support panel;
a blade being pivotally coupled to said cutting board, said blade being urgeable downwardly for cutting a food item positioned on said cutting board, said blade being aligned with said blade slot thereby facilitating said blade to pass into said blade slot when said blade is urged downwardly for fully cutting through the food item;
a handle being attached to said blade thereby facilitating said handle to be gripped for moving said blade upwardly and downwardly;
wherein said cutting board has a top surface, a bottom surface and a perimeter surface extending between said top surface and said bottom surface, said perimeter surface having a front side and a back side, said blade slot extending downwardly into said top surface, said blade slot extending through said front side and said back side of said perimeter surface, said blade slot being centrally positioned on said cutting board;
wherein said cutting board has a pair of lobes each extending upwardly from said top surface, each of said lobes being positioned to extend along opposite sides of said blade slot with respect to each other, each of said lobes extending from said back side of said perimeter surface toward said front side of said perimeter surface:
wherein each of said couplers is positioned on said bottom surface of said cutting boards, each of said couplers being aligned with a respective one of four corners of said perimeter surface;
wherein said blade has a first end, a second end and a cutting edge extending between said first end and said second end, said blade being elongated between said first end and said second end, said second end being positioned between said pair of lobes; and
a pin extending through each of said lobes and engaging said blade such that said blade is pivotally attached to each of said lobes at a fixed pivot point relative to said cutting board.

2. (canceled)

3. The assembly according to claim 1, wherein said clamp comprises a central member extending between a pair of end members, each of said end members being perpendicularly oriented with said central member such that said clamp has a U-shape, a distal end of a top one of said end members being coupled to said front side of said perimeter surface such that said central member extends downwardly from said cutting board having a bottom one of said end members extending along a line being oriented parallel with said bottom surface of said cutting board.

4. The assembly according to claim 3, wherein said clamp includes a screw extending through said bottom end member, said screw having a plate being urgeable toward said top end member when said screw is tightened thereby facilitating the support panel to be compressed between said plate and said top end member, said plate being urgeable away from said top end member when said screw is loosened thereby facilitating the support panel to be removed from between said plate and said top end member.

5. (canceled)

6. The assembly according to claim 5, wherein said handle is positioned on said first end of said blade having said handle extending along an axis extending between said first end and said second end of said blade, said handle having a rounded outer surface such that said handle has a cylindrical shape for enhancing comfort for the user.

7. A cutting board assembly being attachable to a support panel for cutting large vegetables, said assembly comprising:
a cutting board having a blade slot extending along a full length of said cutting board, said cutting board having a top surface, a bottom surface and a perimeter surface extending between said top surface and said bottom surface, said perimeter surface having a front side and a back side, said blade slot extending downwardly into said top surface, said blade slot extending through said front side and said back side of said perimeter surface, said blade slot being centrally positioned on said cutting board, said cutting board having a pair of lobes each extending upwardly from said top surface, each of said lobes being positioned to extend along opposite sides of said blade slot with respect to each other, each of said lobes extending from said back side of said perimeter surface toward said front side of said perimeter surface;
a plurality of couplers, each of said couplers being coupled to said cutting board thereby facilitating each of said couplers to releasably engage a support panel for mounting said cutting board on the support panel, each of said couplers being positioned on said bottom surface of said cutting boards, each of said couplers being aligned with a respective one of four corners of said perimeter surface;
a clamp being coupled to said cutting board thereby facilitating an edge of the support panel to be positioned in said clamp, said clamp engaging the support panel when said clamp is tightened for securing said cutting board to the support panel, said clamp comprising a central member extending between a pair of end members, each of said end members being perpendicularly oriented with said central member such that said clamp has a U-shape, a distal end of a top one of said end members being coupled to said front side of said perimeter surface such that said central member extends downwardly from said cutting board having a bottom one of said end members extending along a line being oriented parallel with said bottom surface of said cutting board, said clamp including a screw extending through said bottom end member, said screw having a plate being urgeable toward said top end member when said screw is tightened thereby facilitating the support panel to be compressed between said plate and said top end member, said plate being urgeable away from said top end member when said screw is loosened thereby facilitating the support panel to be removed from between said plate and said top end member;
a blade being pivotally coupled to said cutting board, said blade being urgeable downwardly for cutting a food item positioned on said cutting board, said blade being aligned with said blade slot thereby facilitating said blade to pass into said blade slot when said blade is urged downwardly for fully cutting through the food item, said blade having a first end, a second end and a cutting edge extending between said first end and said second end, said blade being elongated between said first end and said second end, said second end being positioned between said pair of lobes;
a pin extending through each of said lobes and engaging said blade such that said blade is pivotally attached to each of said lobes at a fixed pivot point relative to said cutting board; and
a handle being attached to said blade thereby facilitating said handle to be gripped for moving said blade upwardly and downwardly, said handle being positioned on said first end of said blade having said handle extending along an axis extending between said first end and said second end of said blade, said handle having a rounded outer surface such that said handle has a cylindrical shape for enhancing comfort for the user.
